(19) United States
(12) Patent Application Publication
(10) Pub. No.: US 2016/0085538 A1
(43) Pub. Date: Mar. 24, 2016

(54) OVER-THE-AIR UPDATES FOR BLE DEVICES

(71) Applicant: Qualcomm Technologies International, Ltd., Cambridge (GB)

(72) Inventor: Simon Finch, Newmarket (GB)

(21) Appl. No.: 14/492,232

(22) Filed: Sep. 22, 2014

(51) Int. Cl. G06F 9/445; H04W 8/24; H04L 29/08

(52) U.S. Cl. CPC G06F 8/65; H04L 67/10; H04W 8/245

(57) ABSTRACT

A method for updating a Bluetooth Low Energy (BLE) device from a host device, the BLE device including a processor, a non-volatile memory and a volatile memory, and being capable of data transfer via a Human Interface Device (HID) service, said non-volatile memory including partitions for a plurality of application images, said method including configuring a pointer to instruct the processor to copy a first application image in a first partition of the non-volatile memory to the volatile memory when the device starts up; transferring a second application image from the host device to a second partition of the non-volatile memory using Bluetooth HID service; and re-configuring the pointer to instruct the processor to copy the second application image in the second partition of the non-volatile memory to the volatile memory when the device next starts up if the second application image is error free.

### TECHNICAL FIELD

This invention relates to a method and system for updating an application on a Bluetooth Low Energy (BLE) device.

### BACKGROUND

Bluetooth technology enables short-range wireless communication between devices. For example, when Bluetooth wireless technology is implemented in Human-Interface-Devices (HIDs) such as remote controls or keyboards control signals may be sent wirelessly. Bluetooth Low Energy (BLE) is a particular form of the Bluetooth standard focused on providing reduced power consumption and cost.

BLE HID devices implement HID services using the Bluetooth Generic ATTribute profile (GATT). The GATT profile makes use of characteristic descriptors and associated values that can be understood by compatible HID devices.

Over The Air (OTA) update processes allow the software on devices to be updated over a wireless link. A conventional OTA update process involves booting the device into an update mode and then transferring an updated software image over the air. The usual functions of the device are not available while the device is in the update mode and so the user is unable to use the device for a period of time.

There is therefore a need for a method of updating wireless devices without interrupting the device operation.

### SUMMARY OF THE INVENTION

There is provided a method for updating a Bluetooth Low Energy (BLE) device from a host device, the BLE device comprising a processor, a non-volatile memory and a volatile memory, and being capable of data transfer via a Human Interface Device (HID) service, said non-volatile memory comprising partitions for a plurality of application images, said method comprising: configuring a pointer to instruct the processor to copy a first application image in a first partition of the non-volatile memory to the volatile memory when the device starts up; transferring a second application image from the host device to a second partition of the non-volatile memory using Bluetooth HID service; and re-configuring the pointer to instruct the processor to copy the second application image in the second partition of the non-volatile memory to the volatile memory when the device next starts up if the second application image is error free.

A selection of optional features is set out in the dependent claims.

### FIGURES

FIG. 1 is a block diagram of a system for updating a BLE device;

FIG. 2 is a diagram illustrating the internal architecture of a BLE device;

FIG. 3 is a schematic diagram of a non-volatile memory utilisation;

FIGS. 4 and 5 show flowcharts of a method of updating a BLE device; and

FIG. 6 is a flowchart of a method of starting a BLE device.

### DETAILED DESCRIPTION

The present invention relates to a method of updating an application in a BLE device without interrupting operation of the device. This is achieved by adding an Over The Air Update (OTAU) extension to the BLE protocol allowing an application to be transferred to a BLE device using the HID service. Software on the BLE device allows the reception and storage of updated applications, and manages the selection and activation of application images for operation of the device. The OTAU over HID service enables the transmission of an application utilising HID reports provided by the HID service without interrupting operation of the device. Systems are provided to ensure only valid applications are activated thus ensuring there is no risk of loss of operation due to an updated application being deployed.

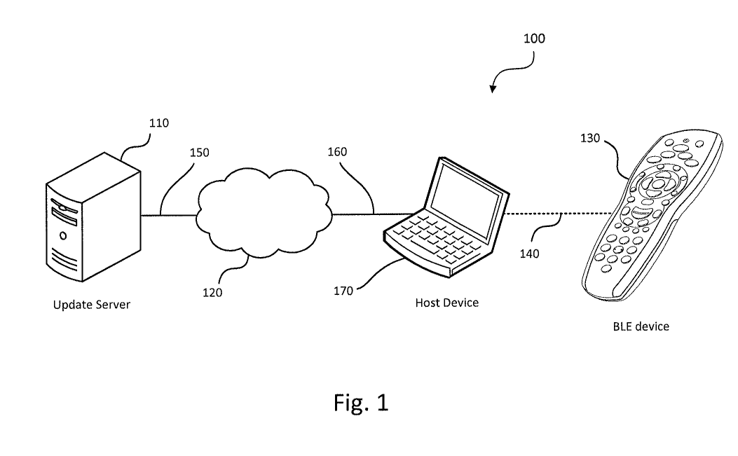

FIG. 1 illustrates an exemplary system 100 in which data may be transmitted from a host device 170 to a BLE device 130 and vice-versa. An update server 110 may communicate with the host device 170 through network 120 to transfer an updated application image to the host device 170. The host device 170 initiates and manages the OTAU over HID processes.

The host device 170 is generally a computing device having Bluetooth (in particular BLE) functionality. For example, host device 170 may be a computer or mobile phone to which the BLE device is connected by a BLE radio connection. BLE device 130 is a BLE HID device such as a keyboard or a remote control.

The host device 170 runs at least HID driver and device management software. The HID driver is a conventional HID driver as is known for use with HID systems. The device management software manages and implements the deployment of updates to the BLE device over the Bluetooth HID connection. The device management software operates by transmitting and receiving data through the HID driver in the conventional manner. The system utilises standard HID reports, which are directed by the HID driver to the OTAU software to transfer data to and from the device. Utilising standard HID drivers allows simpler deployment and implementation as only the device-specific software requires customisation.

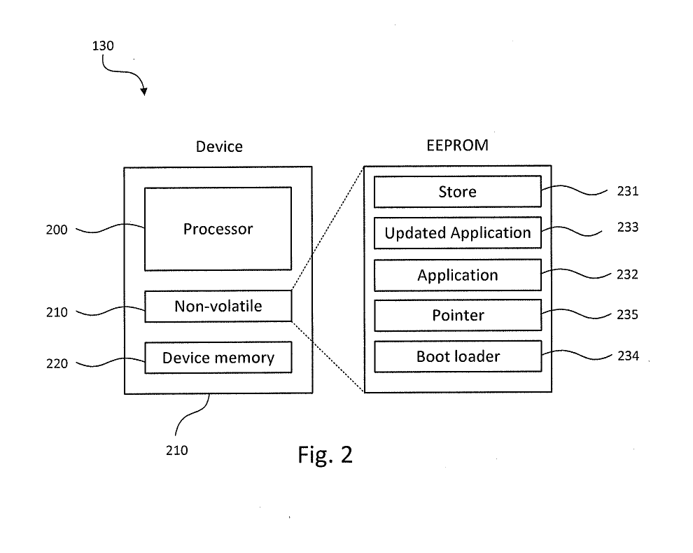

An exemplary internal architecture of relevant parts of the BLE device 130 is shown in FIG. 2. The device 130 comprises a control unit/processor 200, a non-volatile memory 210, and a device memory 220. In an embodiment, the non-volatile memory 210 may be an Electrically Erasable Programmable Read-Only Memory (EEPROM), and the device memory 220 may be a Random-Access Memory (RAM).

Non-volatile memory 210 is utilised to store data and applications for operation of the device. Boot-loader application image 234 is an application which loads an application image into device memory and runs it. The boot-loader does not have any other functions and thus may be smaller than conventional boot-loader applications which may perform additional functions. Images of two or more applications 232, 233 are stored in the non-volatile memory. When the boot-loader runs one of these application images is transferred to the device memory 220, with the relevant image being indicated by pointer 235. Pointer 235 indicates the currently active image which is to copied by the boot-loader to the device memory 220. A store area 231 is provided to store data and variables relevant to each of the applications.

In an embodiment a first application image 232 is a Factory or Golden image (referred to as the Factory image below) which is an application which is known to be good and is typically pre-stored in the device during manufacture. If it is desired to update the application after deployment a new application may be stored as the updated application 233. Once the updated application has been successfully stored and verified pointer 235 is updated to indicate to the boot-loader application that this application should be copied to the device memory 220 when the device starts. When the device is next started, the boot-loader application copies the updated application 233 to the device memory 220 as indicated by pointer 235. The updated application 233 is thus utilised and provide updated or new functionality to the user, or may be a completely different application.

The Factory image 232 is not affected by storing the updated image 233. Should any errors occur with the updated application image the device can resume utilising Factory image 232 by updating the pointer 235 to indicate the Factory image 232 as the active image. The update process described herein does not carry any risk of causing errors in the device, for example causing it to become inoperable due to the transfer of an erroneous image as the Factory image is always available as a backup.

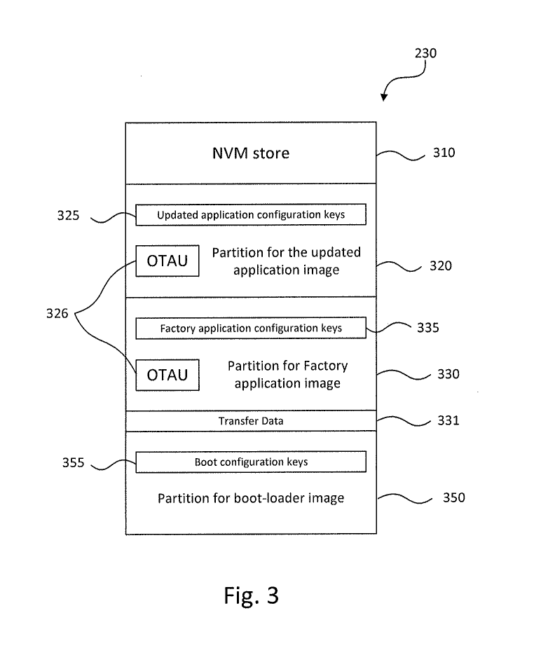

FIG. 3 shows an exemplary map of non-volatile memory 230 and how it may be partitioned for operation in accordance with the principles set out herein.

Partition 330 stores a Factory application which is a known-good application pre-stored during manufacture. The application also comprises information 335 defining configuration key settings of the device as configured for use with the Factory application. The partition 330 is not modified during normal operation of the device as it provides a “safe” application for operation of the device.

Partition 320 is provided to store an updated application image. Upon initial manufacture no application image may be stored in this partition as it is utilised to store an updated application provided after sale of the device. Alternatively an application may already be provided on manufacture as an alternative or replacement for the Factory image. The application also comprises information 325 defining configuration keys of the device as configured for use with the updated application.

Partition 350 stores the boot-loader application image. As explained above, when the device starts up the boot-loader application image is copied to the device memory 220 and run. The boot-loader application's function is to copy an application image to the device memory and run it. Transfer data partition 331 stores a pointer 235 which indicates the active application image which is copied to the device memory 220 by the boot-loader. The transfer data partition 331 is written with the Factory image during manufacture and thus is not generally modified during the life of the device (as described below, the pointer 235 is updated during use). The values may be utilised by any of the applications on the device.

As well as code for device functionality the application images also contain OTAU over HID update functions 326 to allow updating of the device. The OTAU over HID update functions may be provided in the form of a library which can be included in a device manufacturer's application.

The store 310 is used to store data used by the each of the applications. The store 310 may store connection information such as the bonded device's Bluetooth address and any security keys required to make a BLE connection. When the updated application is copied to the device memory 220 and run instead of the Factory application, the updated application uses the information in the store 310 to resume any bonding and connections configured by the Factory application prior to the update.

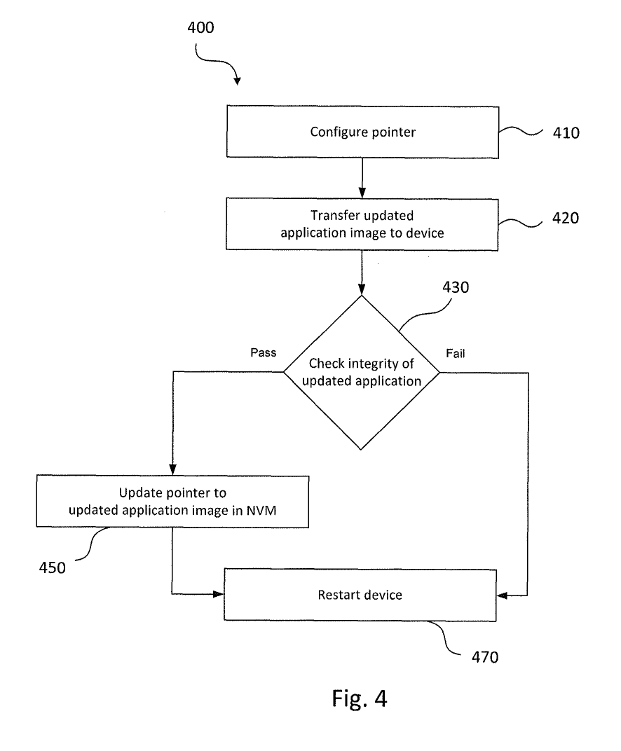

The principle features of a method of updating a BLE device 130 are shown in the flow diagram 400 of FIG. 4.

The update process is managed and run by the host device which sends appropriate commands and data to the BLE device through the BLE connection to the device. These are interpreted by the OTAU function in the application on the device.

At step 410 the pointer 235 is configured to indicate that the Factory image is the active image. This ensures that if the update fails and the updated image is not operable, the device will restart from the Factory image and the device will continue to operate. It is thus ensured that operation of the device is not affected even if the update fails.

At step 420 an updated application image is transferred to the BLE device and stored in the updated application image partition 320. Once the image has been transferred it is verified at step 430, for example by a CRC checksum calculation. If the updated application passes the verification, at step 450 the pointer is updated to indicate the updated application image as the active image.

At step 470 the device may be restarted to cause the boot-loader to copy the update application image to device memory. As discussed in more detail below, this re-start may be performed upon completion of the update, or as a separate, later, process. For example, the device may be restarted the next time the device disconnects from the host. Until the device is restarted the device continues operating the application which was loaded into the device memory by the boot-loader at the last restart and so there is no effect on on-going operation. Once the device is restarted (assuming the update was successful) the updated application is copied to the device memory and utilised for continued operation. If the update was not successful the next restart will load the Factory image to the device memory which is used for operation. If, prior to the update, the device was running updated software this may result in a ‘downgrade’ of the device software, but this is preferable to a complete failure which may occur with other update mechanisms.

In general, it is preferable for the application to be transferred while the device is in a standby mode, but still connected to the host device. For example, the image may be transferred while the host detects the BLE device is not being operated and is in a sleep mode, but is still capable of communication with the host. The host device is aware of the status of the transfer and so can pause and resume transfer if the device is used during the process, thus avoiding any impact on device performance. Since the update process does not affect the currently-running application in device memory, nor the Factory image, there is no impact on device operation if this occurs even if the update is paused indefinitely.

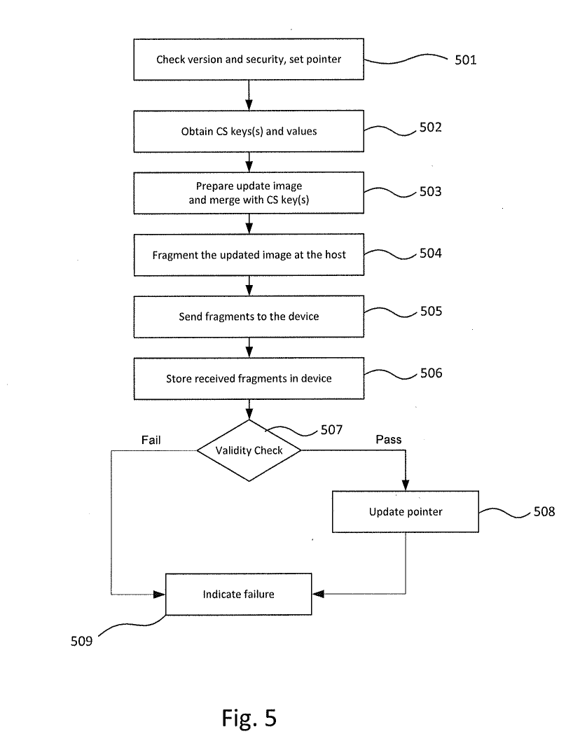

Further details of the method of updating the BLE device 130 shown in FIG. 4 are shown in FIG. 5.

At step 501 preliminary steps such as checking protocol versions and verifying security keys may be conducted, as is known in the art, and the pointer 235 is set to indicate that the Factory image is the active image.

At step 502 configuration key values are read from the device. These are the values currently set in the device which define behaviour of the device and may be configured by the user. Reading these values and incorporating the values into the updated application image ensures continuity of operation after the upgrade. If this step was not performed the user's customisation would be lost during the upgrade. It is necessary to include these values in the application image as they are required in the device memory for operation and are thus copied to the device memory with the application image. The configuration key values are requested by the host device and returned by the BLE device. The keys may be requested sequentially, or as single set. The host monitors reception of the key data and should any errors be detected the process may be repeated to ensure a complete set of data is received.

At step 503 the configuration key values are merged with an updated application that is to be transferred to the device to form the application for transfer. At step 504 the merged application image is fragmented into fragments of appropriate size for transfer to the BLE device using the HID service. For example, a convenient fragment size for transfer utilising reports provided by the HID service may be 1-20 octets of data.

At step 505 the fragments are transferred sequentially to the BLE device utilising the HID service. In a particular example, the host transmits an indication to the BLE device of which application should be updated, and requests confirmation that the BLE device is ready to accept the application. Once this is received transmission of the fragments is commenced.

Steps 504 and 505 may be conducted sequentially or in parallel. For example, a full set of fragments may be produced and then transmitted, or each fragment may be prepared as it is required to be sent.

The HID service utilised for transfer of the image has a relatively low bandwidth for data transmission and accordingly transfer of the application may take a significant period of time. There is thus a reasonable probability of an interruption occurring, for example due to the battery going flat or communication being lost. Such a failure will result in the application image being incompletely transferred and thus unable to be utilised. If the failure occurs due to a battery going flat, when the battery is replaced the device will restart and because the pointer was set to Factory image prior to commencing the update, that application will be utilised for the restart. The incomplete updated application will thus not affect operation of the device.

At step 506 the BLE device stores the fragments in the appropriate partition of the Non-Volatile Memory of the device, overwriting any previous application in that location. The fragments are transmitted sequentially by the host device and thus are also stored sequentially in the order received. In an example, error checking and flow control is present to ensure the fragments are correctly received, this is provided by the Bluetooth low energy protocol which is inherently reliable.

At step 507 the validity of the transferred application image is verified, for example by calculating a CRC checksum for the transferred application image. If the validity check is successful, and indicates the updated application image has been correctly stored, the pointer 235 is updated at step 508 to indicate that the updated application image is the active image. If the validity check is not successful and indicates errors in the stored application, the pointer is left indicating the Factory application as the active application.

An indication of the success or failure of the update may be sent to the host at step 509. In certain examples this indication may not be sent, but the host may transmit a query to the device as to which application is active, from which the success or failure of the update. Alternatively no check or enquiry as to the success may be made.

The host may then issue a command to the BLE device to re-start, thus causing the updated application (if update was successful) to be transferred to the device memory and run. The device is thus operating using the updated software. If the update has failed the device will re-start on the Factory application. The host may cause the BLE device to restart immediately after completion of the update, or at a later time which appears to be convenient. Alternatively the device may not be restarted specifically in connection with the update, but rather the next natural restart may be utilised to commence operation with the updated application.

After the update and re-start the BLE re-establishes connections according to the data stored in the NVM store which is accessible and utilised by all applications which may on the device. No re-configuration of the device is thus required after an update and all existing connections can be re-established.

The host device may be configured to periodically poll the BLE device to ascertain the active application. The result may be compared with an internal record of which application should be active. If the host device expects the updated application to be active, but in fact the Factory application is active, it can be inferred that the update failed and needs to be attempted again. The host may then utilise the method of FIG. 5 to attempt the update again.

In the examples described above a pointer is provided to indicate the currently active application. In an alternative example a pointer may not be utilised, but the boot loader may be configured to load the updated application image, unless such an application image is not present or is not valid, in which case the Factory image is utilised by the boot-loader.

Prior to commencing the update process, the host may confirm that the battery level in the BLE device is sufficient to keep the device running for the duration of the update process in order to ensure the process completes successfully.

The host device application may include functionality to periodically check for the availability of updates at update server 110, and to schedule those updates. For example, the host device application may be configured to schedule updates for during the night when the device is less likely to be utilised.

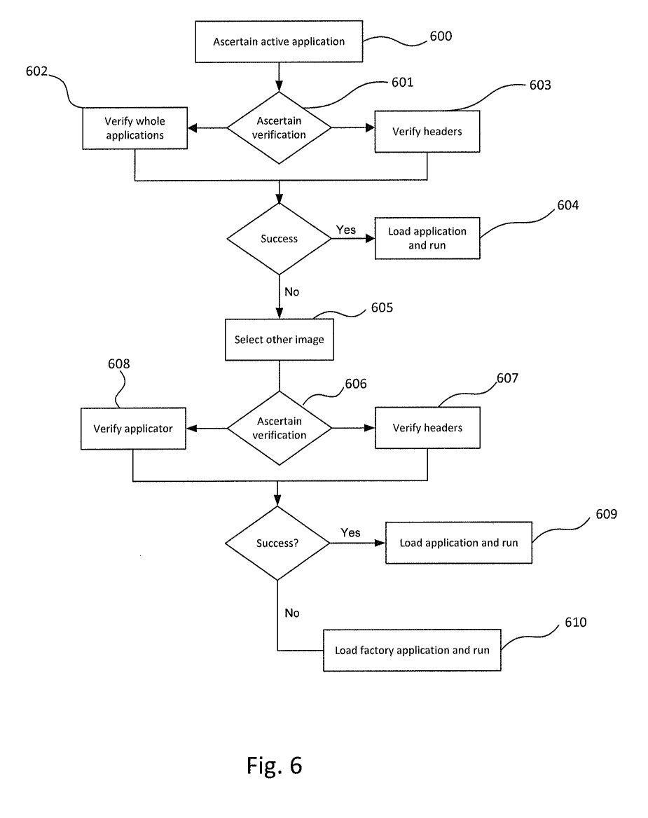

FIG. 6 shows a flow-chart of a method which may be performed by the boot-loader application to work in conjunction with the update methods described herein. At step 600 the boot loader ascertains the currently active application by reading the pointer value from the transfer data partition of non-volatile memory. At step 601 the boot-loader ascertains the current verification configuration and either verifies the whole application (step 602), or only verifies (step 603) the headers of the image. Verifying the entire application may improve reliability but leads to slower startup as the verification process takes time.

If the verification succeeds the indicated application is loaded at step 604. If the verification fails, the boot-loader is changed at step 605 to select the other application image. That is, if step 600 indicated the updated application image, the boot-loader now selects the Factory image and vice-versa. At steps 606, 607, 608 the verification process described above is conducted, and if successful at step 609 the newly indicated application is loaded and run. If this verification also fails the Factory application is loaded and run at step 610 in an effort to provide some functionality to the user.

It will be understood that the above methodology may be implemented as computer readable instructions to be read in by a computer processor. The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants, remote controls and many other devices. Those skilled in the art will also realise that the term ‘profiles’ in relation the described method may be implemented in a memory or part thereof as a string of computer code.

Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method for updating a Bluetooth Low Energy (BLE) device from a host device, the BLE device comprising a processor, a non-volatile memory and a volatile memory, and being capable of data transfer via a Human Interface Device (HID) service, said non-volatile memory comprising partitions for a plurality of application images, said method comprising:
configuring a pointer to instruct the processor to copy a first application image in a first partition of the non-volatile memory to the volatile memory when the device starts up;
transferring a second application image from the host device to a second partition of the non-volatile memory using Bluetooth HID service; and
re-configuring the pointer to instruct the processor to copy the second application image in the second partition of the non-volatile memory to the volatile memory when the device next starts up if the second application image is error free.

2. The method according to claim 1 further comprising the step of verifying the second application image prior to re-configuring the pointer, and only re-configuring the pointer if the image passes the verification.

3. The method according to claim 1 further comprising the step of the host obtaining data defining the function of configuration keys and merging that data with an application image, the merged image being transferred to the BLE device.

4. The method according to claim 1 wherein the step of transferring the second application image comprises fragmenting the second application image in the host device; and transferring each fragment of the mapped second application image from the host device to the BLE device.

5. The method according to claim 4, wherein the step of transferring comprises sequentially transferring each fragment of the mapped application image from the host device to the BLE device.

6. The method according to claim 1, wherein the second application image, once transferred to the BLE device, is stored in an application partition in the non-volatile memory of the BLE device.

7. The method according to claim 6, wherein the first application image is pre-stored in a first application partition in the non-volatile memory of the BLE device.
